(19) United States
(12) Patent Application Publication
(10) Pub. No.: US 2007/0047503 A1
(43) Pub. Date: Mar. 1, 2007

(54) METHOD AND APPARATUS FOR DYNAMIC TIME SLOT ALLOCATION

(75) Inventors: Ilya O. Gonorovsky, E. Brunswick, NJ (US); Niels Peter Skov Andersen, Roskilde (DK)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/465,862

(22) Filed: Aug. 21, 2006

Related U.S. Application Data
(60) Provisional application No. 60/711,160, filed on Aug. 25, 2005.

(51) Int. Cl. H04B 7/212

(52) U.S. Cl. 370/337; 370/458

(57) ABSTRACT

A communication system utilizes a Downlink Radio Link Control (RLC) data block conveyed to a mobile station (MS) via a first downlink time slot to inform the MS of an allocation of a second downlink time slot, which Downlink RLC data block is conveyed to the MS regardless of the allocation. By utilizing the Downlink RLC data block, the communication system informs the MS of the dynamically allocated time slot without the specialized messages of, and the additional bandwidth consumed by, the prior art. Furthermore, when the first downlink time slot comprises a bearer channel already allocated to the MS, the system then provides for in-band signaling of the MS of the newly allocated time slot.

### CROSS-REFERENCE(S) TO RELATED APPLICATION(S)

The present application claims priority from provisional application Ser. No. 60/711,160, entitled “METHOD AND APPARATUS FOR DYNAMIC TIME SLOT ALLOCATION,” filed Aug. 25, 2005, which is commonly owned and incorporated herein by reference in its entirety.

### FIELD OF THE INVENTION

The present invention relates generally to wireless communication systems, and, in particular, to an allocation of a time slot to a user of a wireless communication system.

### BACKGROUND OF THE INVENTION

The General Packet Radio Service (GPRS) standard provides a compatibility standard for cellular mobile telecommunications systems. The GPRS standard ensures that a mobile station (MS) operating in a GPRS system can obtain communication services when operating in a system manufactured according to the standard. To ensure compatibility, radio system parameters and call processing procedures are specified by the standard, including call processing steps that are executed by an MS and a base station serving the MS in order to establish a call and control messages that are exchanged between elements of an infrastructure that includes the base station.

In a GPRS communication system, a frequency bandwidth is divided into eight time slots (using the same frame structure as in Global System for Mobile communications (GSM)) that provide the physical communication channels and which eight time slots constitute a frame. In order for an MS to receive a data transfer, such as PS (packet switched) voice or user data and typically in a format of a Radio Downlink Control (RLC) data block, from a network serving the MS, the network must first allocate to the MS a downlink packet data channel comprising one or more time slots in a given frequency bandwith. The network then informs the MS of the allocated time slot(s) via a Packet Downlink Assignment command.

Once the time slot(s) is(are) assigned, the MS then monitors only the assigned time slot(s) in order to receive the data. The time slot remains assigned to the MS for a duration of a Temporary Block Flow (TBF) or until the MS receives a Packet Timeslot Reconfigure command. However, situations arise wherein one or more previously allocated time slots may become available for additional allocation to the MS. For example, FIG. 1 depicts an exemplary time slot allocation in a frequency bandwidth in accordance with the prior art. During a first time period, t₁, corresponding to a transmission of a first Downlink Radio Link Control data block, each of eight time slots 100-107 of a frame is allocated to an MS. In the GPRS communication system, voice, user data, and control information is transferred over an air interface in blocks. Each block has a duration of four bursts which are sent in succession in one physical channel. That is, each block is transferred using four time slots, which four time slots comprise a same time slot in each of four consecutive frames. As depicted in FIG. 1, MSs allocated six of the eight time slots, that is, MSs allocated time slots 100-103, 105, and 107, each utilizes a same time slot available to the MS in all four frames for a transfer of a first block to the MS over the first time period. For example, an MS allocated time slot 100 utilizes the time slot in each of frames 1, 2, 3, and 4 for a transfer of a block 110 and an MS allocated time slot 107 utilizes the time slot in each of frames 1, 2, 3, and 4 for a transfer of a block 117. However, MSs allocated two of the time slots, that is, time slots 104 and 106, utilize fewer than the time slots available to the MSs in the four frames (which non-utilized time slots are indicated by blank time slots) during the first time period. For example, the MSs allocated time slots 104 and 106 may be receiving voice rather than data and, as a result of the sporadic nature of voice, utilize fewer than the four available time slots.

As a result, during a second time period, t₂, corresponding to a transfer of a second block via each of allocated time slots 100-103, 105, and 107 and a third time period, t₃, corresponding to a transfer of a third block via each of allocated time slots 100-103, 105, and 107, two additional time slots (time slots 104 and 106) are available for reallocation. For example, the MS allocated time slot 100 is transferred a second block 120 during the second time period and is transferred a third block 130 during the third time period. Meanwhile, time slots 104 and 106 are unused, and therefore are available for reallocation, in each of the four frames transmitted during second and third periods. However, in order to reallocate a time slot to an MS and prior to reusing the time slot, the network must first convey a Packet Timeslot Reconfigure message to the MS and then wait for an acknowledgement of the message from the MS. Such signaling consumes system resources and time, with the result that the command cannot be executed on a block-by-block basis and system resources sit idle, depicted in FIG. 1 by the blank time slots 104 and 106 during the second and third time periods.

Therefore, a need exists for a method and apparatus for dynamically allocating time slots that facilitates a more rapid reuse of the the time slots than permitted by the prior art.

### BRIEF DESCRIPTION OF THE DRAWINGS

FIG. 1 is a block diagram illustration of an exemplary allocation of downlink time slots in a frequency bandwidth in accordance with the prior art.

FIG. 2 is a block diagram of a wireless communication system in accordance with an embodiment of the present invention.

FIG. 3 is a logic flow diagram of a method executed by the access network of FIG. 2 in dynamically allocating a downlink time slot in accordance with an embodiment of the present invention.

FIG. 4 is a block diagram illustration of an exemplary allocation of downlink time slots in a frequency bandwidth in accordance with an embodiment (one additional time slot allocated dynamically vs. original allocation) of the present invention.

FIG. 5 is a block diagram illustration of an exemplary allocation of downlink time slots in a frequency bandwidth in accordance with another embodiment (two additional time slots allocated dynamically vs. original allocation) of the present invention.

FIG. 6 is a bit layout of an exemplary Downlink Radio Link Control (RLC) data block in accordance with an embodiment of the present invention.

FIG. 7 is a table listing various values that may be included in a header of a Downlink RLC data block to indicate whether the block includes a pointer to a dynamically allocated time slot in accordance with an embodiment of the present invention.

FIG. 8 is a table listing various bit patterns that may be included in a header of a Downlink RLC data block, and the time slot or time slots associated with each bit pattern, to point to time slots that are dynamically allocated to a mobile station receiving the block in accordance with an embodiment of the present invention.

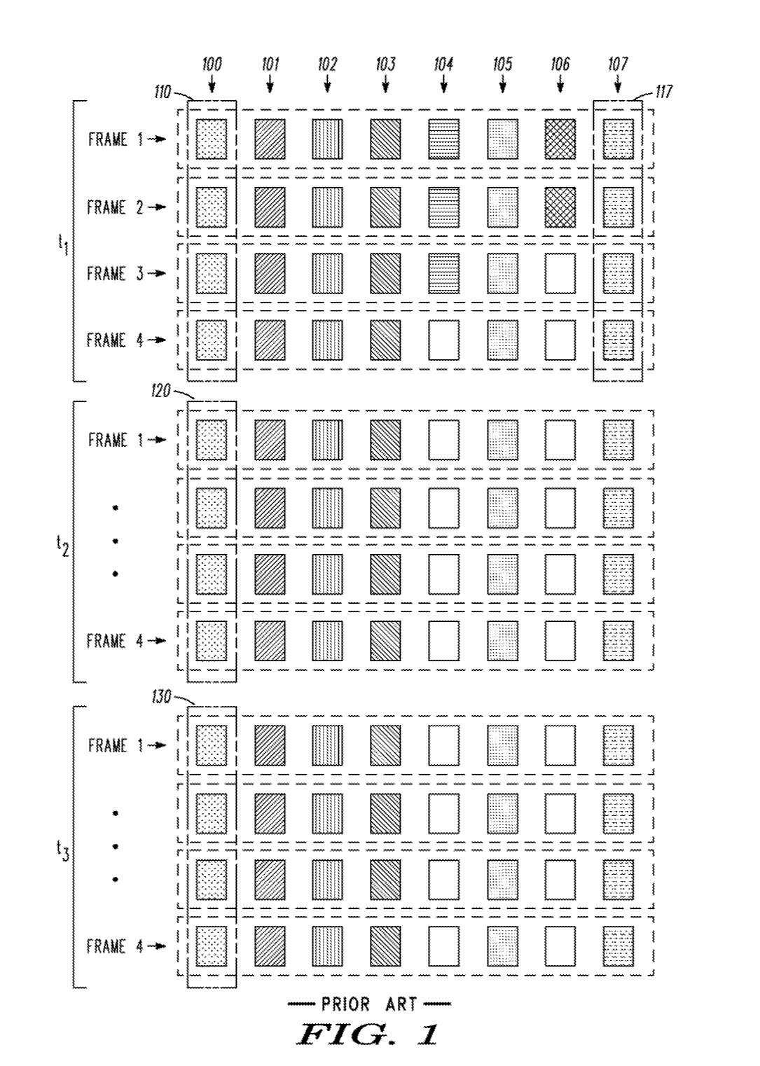

Skilled artisans will appreciate that elements in the figures are illustrated for simplicity and clarity and have not necessarily been drawn to scale. For example, the dimensions of some of the elements in the figures may be exaggerated relative to other elements to help improve understanding of various embodiments of the present invention. Also, common and well-understood elements that are useful or necessary in a commercially feasible embodiment are often not depicted in order to facilitate a less obstructed view of these various embodiments of the present invention.

### DETAILED DESCRIPTION OF THE INVENTION

To address the need for a method and apparatus for dynamically allocating time slots that facilitates a more rapid reuse of the the time slots than permitted by the prior art, a communication system is provided that utilizes a Downlink Radio Link Control (RLC) data block conveyed to a mobile station (MS) via a first downlink time slot to inform the MS of an allocation of a second downlink time slot, which Downlink RLC data block is conveyed to the MS regardless of the allocation. By utilizing the Downlink RLC data block, the communication system informs the MS of the dynamically allocated time slot without the specialized messages of, and the additional bandwidth and response time consumed by, the prior art. Furthermore, when the first downlink time slot comprises a bearer channel already allocated to the MS, the system then provides for in-band signaling of the MS of the newly allocated time slot.

Generally, an embodiment of the present invention encompasses a method for dynamic allocation of a downlink time slot. The method comprises allocating a first downlink time slot to a mobile station, subsequent to allocating the first time slot, determining that a second downlink time slot is available for allocation, wherein the second time slot is different from the first time slot, allocating the second downlink time slot to the mobile station, and informing the mobile station of the allocation of the second downlink time slot via a Downlink Radio Link Control (RLC) data block.

Another embodiment of the present invention encompasses a method for dynamic allocation of a downlink time slot comprising receiving an allocation of a first downlink time slot, subsequent to receiving the allocation of the first downlink time slot, receiving a Downlink RLC data block comprising an allocation of a second downlink time slot different from the first time slot, identifying the second downlink time slot based on the received Downlink RLC data block, and monitoring each of the first downlink time slot and the second downlink time slot.

Yet another embodiment of the present invention encompasses a computer-readable medium that stores instructions for assembling a Downlink RLC data block block for conveyance by an access network to a mobile station, wherein the instructions comprise including an identifier of a downlink time slot in a header of the block.

Still another embodiment of the present invention encompasses an apparatus comprising means for allocating a first downlink time slot to a mobile station, means for determining, subsequent to allocating the first time slot, that a second downlink time slot is available for allocation, means for allocating the second downlink time slot to the mobile station; and means for conveying a Downlink RLC data block to the mobile station that informs of the allocation of the second downlink time slot.

Yet another embodiment of the present invention encompasses a mobile station comprising means for receiving an allocation of a first downlink time slot, means for receiving, subsequent to receiving the allocation of the first downlink time slot, a Downlink Radio Link Control (RLC) data block comprising an allocation of a second downlink time slot, means for identifying the second downlink time slot based on the received Downlink RLC data block, and means for monitoring each of the first downlink time slot and the second downlink time slot.

Still another embodiment of the present invention encompasses a method for in-band signaling of a time slot allocation comprising allocating a bearer channel to a mobile station, wherein the bearer channel comprises a first downlink time slot to a mobile station, subsequent to allocating the bearer channel, determining that a second downlink time slot is available for allocation, wherein the second time slot is different from the first time slot, allocating the second downlink time slot to the mobile station, and informing the mobile station of the allocation of the second downlink time slot via the bearer channel.

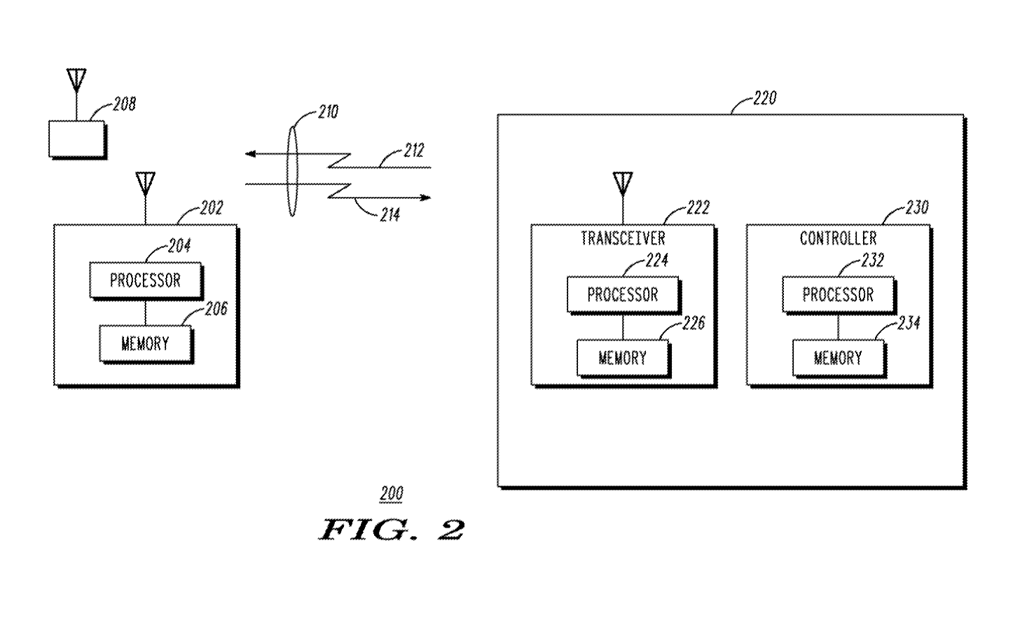

The present invention may be more fully described with reference to FIGS. 2-8. FIG. 2 is a block diagram of a wireless communication system 200 in accordance with an embodiment of the present invention. Communication system 200 includes a wireless access network 220, such as a Radio Access Network (RAN) or a Base Station (BS), that provides wireless communications services to mobile stations (MSs) located in a coverage area serviced by the access network via an air interface 210. Access network 220 comprises multiple network elements including at least one transceiver 222, such as a Base Transceiver Station (BTS) or a Node B, and a controller 230, such as a Radio Network Controller (RNC) or a Base Station Controller (BSC), that is operably coupled to the transceiver.

Communication system 200 further includes multiple MSs 202, 208 (two shown), such as but not limited to a cellular phone, a radiotelephone, or a wireless communication-enabled personal computer, laptop computer, or personal digital assistant (PDA), servided by access network 220. Air interface 210 includes a downlink 212 having multiple logical and transport channels including multiple downlink traffic channels and at least one downlink signaling channel. Air interface 210 further includes an uplink 214 having multiple logical and transport channels including multiple uplink traffic channels and at least one uplink signaling channel. In communication system 200, a frequency bandwidth is divided into multiple time slots and each transport channel comprises one or more time slots of the multiple time slots.

Each of MSs 202 and 208 includes a respective processor 204, such as one or more microprocessors, microcontrollers, digital signal processors (DSPs), combinations thereof or such other devices known to those having ordinary skill in the art. The particular operations/functions of processor 204, and respectively thus of MSs 202 and 208, are determined by an execution of software instructions and routines that are stored in a respective at least one memory device 206 associated with the processor, such as random access memory (RAM), dynamic random access memory (DRAM), and/or read only memory (ROM) or equivalents thereof, that store data and programs that may be executed by the corresponding processor. Further, each of transceiver 222 and controller 230 includes a respective processor 224, 232 such as one or more microprocessors, microcontrollers, digital signal processors (DSPs), combinations thereof or such other devices known to those having ordinary skill in the art. The particular operations/functions of processors 224 and 232, and respectively thus of transceiver 222 and controller 230, are determined by an execution of software instructions and routines that are stored in a respective at least one memory device 226, 234 associated with the processor, such as random access memory (RAM), dynamic random access memory (DRAM), and/or read only memory (ROM) or equivalents thereof, that store data and programs that may be executed by the corresponding processor. Further, the particular operations/functions performed herein by access network 220 may be performed by transceiver 222, controller 230, or may be distributed between the transceiver and the controller. Each of MSs 202 and 208 and transceiver 224 further includes a transmitter (not shown) and a receiver (not shown) for wirelessly transmitting and receiving messages, such as a channel assignment message and a Radio Downlink RLC data block block.

The embodiments of the present invention preferably are implemented within MSs 202 and 208, transceiver 222, and controller 230, and more particularly with or in software programs and instructions stored in the respective at least one memory device 206, 226, 234 and respectively executed by processors 204, 224, 232. However, one of ordinary skill in the art realizes that the embodiments of the present invention alternatively may be implemented in hardware, for example, integrated circuits (ICs), application specific integrated circuits (ASICs), and the like, such as ASICs implemented in one or more of the MS 202, transceiver 222, or controller 230. Based on the present disclosure, one skilled in the art will be readily capable of producing and implementing such software and/or hardware without undo experimentation.

Communication system 200 comprises a wireless packet data communication system. In order for MSs 202 and 208 to establish a packet data connection with access network 220, each of the MSs and access network operates in accordance with well-known wireless telecommunications protocols. By operating in accordance with well-known protocols, a user of an MS can be assured that the MS will be able to communicate with access network 220 and establish a packet data communication link with an external network via the access network. Preferably, communication system 200 operates in accordance with the General Packet Radio Service (GPRS) standard, which standard specifies wireless telecommunications system operating protocols, including radio system parameters and call processing procedures. In a GPRS communication system, a frequency bandwidth is divided into eight time slots, which eight time slots constitute a frame, and a physical communication channel comprises one or more of the time slots. However, those who are of ordinary skill in the art realize that communication system 200 may operate in accordance with any one of a variety of communication systems utilizing time slots for a conveyance of voice and/or data, such as a Global System for Mobile communication (GSM) communication system, a Time Division Multiple Access (TDMA) communication system, or a Wideband Code Division Multiple Access (WCDMA) system.

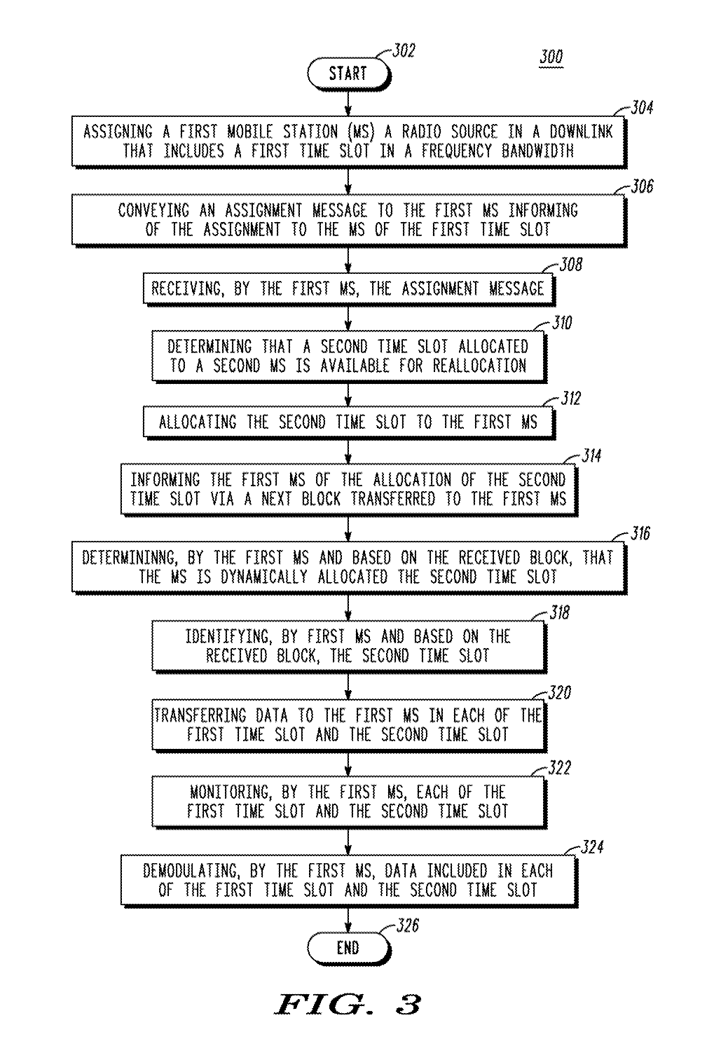

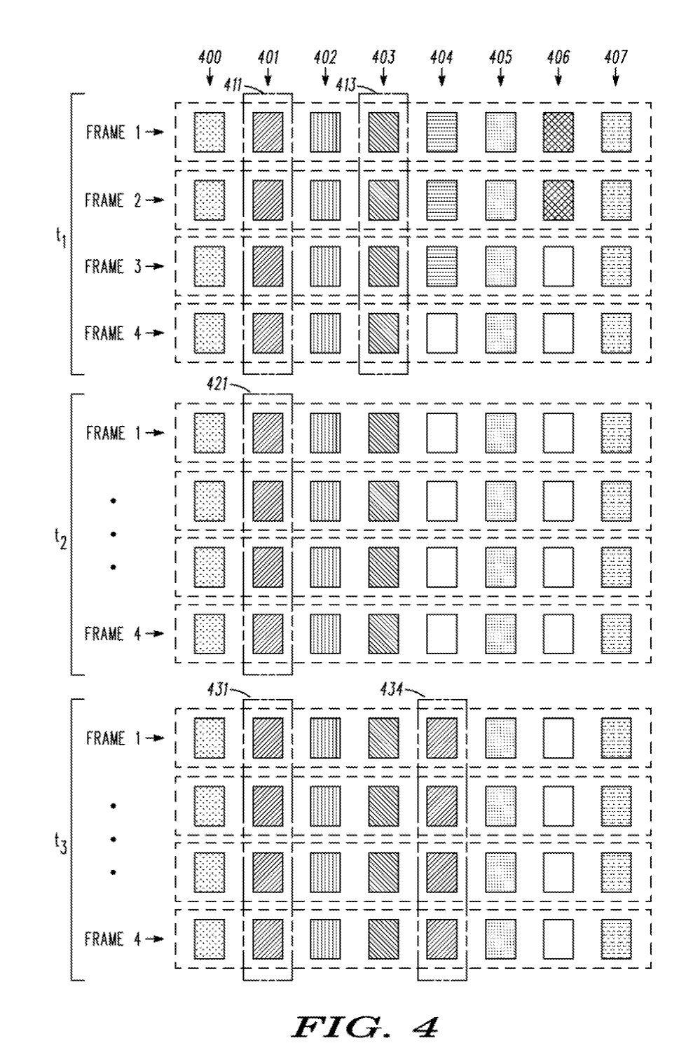

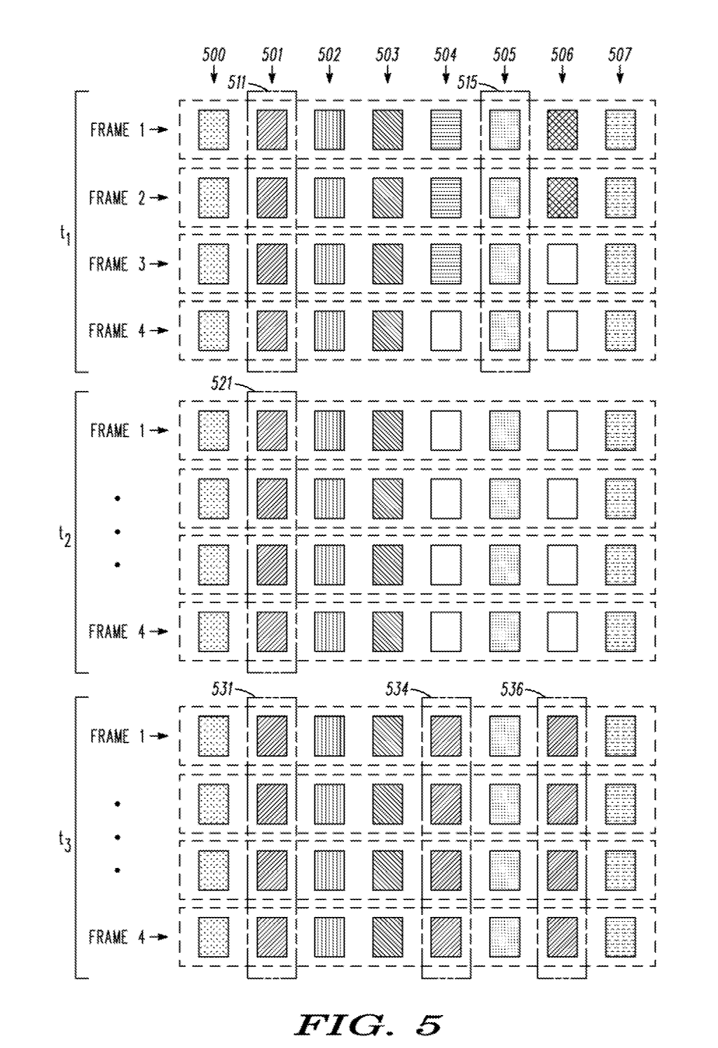

Referring now to FIGS. 2-5, a method is described by which communication system 200 dynamically allocates a downlink time slot to an MS serviced by the communication system. FIG. 3 is a logic flow diagram 300 of a method executed by the access network of FIG. 2 in dynamically allocating a downlink time slot in accordance with an embodiment of the present invention. FIG. 4 is a block diagram illustrating an exemplary allocation of downlink time slots in a given frequency bandwidth in accordance with an embodiment of the present invention, and FIG. 5 is a block diagram illustration of an exemplary allocation of downlink time slots in a given frequency bandwidth in accordance with another embodiment of the present invention.

Logic flow diagram 300 begins (302) when a call is initiated between access network 220 and a first MS serviced by the access network, such as MS 202, in accordance with well known techniques. For example, the first MS, that is, MS 202, may originate a data (GPRS) call with access network 220 or the MS may be paged for a data call by the access network. In response to the initiation of the data call, access network 220 establishes a Temporary Block Flow (TBF) in downlink 212 to support a conveyance of Radio Downlink RLC data blocks to MS 202. As part of the establishment of the TBF, access network 220 assigns (304) to MS 202 a radio resource in downlink 212 that includes a first time slot in a given frequency bandwidth. Access network 220 then conveys (306) to MS 202, and the MS receives (308) from the access network, an assignment message informing of the assigned time slot. The first time slot may comprise a dedicated signaling channel or may comprise a bearer channel used for a conveyance of bearer traffic, such as voice or user data, to the MS.

For example, as depicted in FIG. 4, access network 220 may assign a time slot 401 in downlink 212 to MS 202. By way of another example and as depicted in FIG. 5, access network 220 may assign a time slot 501 in downlink 212 to MS 202. For the purpose of illustrating the principles of the present invention and not intending to limit the invention in any way, FIGS. 4 and 5 further depict an allocation of other time slots, that is, time slots 400 and 402-407 in FIG. 4 and time slots 500 and 502-507 in FIG. 5, of multiple time slots in downlink 212 and in a same frequency bandwidth as time slot 401 assigned to MS 202, to other MSs serviced by access network 220, such as MS 208. That is, each of time slots 400 and 402-407 in FIG. 4 and time slots 500 and 502-507 in FIG. 5 is allocated to an MS other than MS 202.

Access network 220 then transfers data to each MS allocated a time slot 400-407 (or 500-507 with respect to FIG. 5) via a corresponding first Downlink RLC data block and over a first time period, t₁. For example, with respect to FIG. 4, access network 220 transfers block 411 to MS 202 via time slot 401 and frames 1, 2, 3, and 4 and over time period t₁, and access network 220 transfers block 413 to an MS allocated time slot 403 via time slot 403 and frames 1, 2, 3, and 4 and over time period t₁. Similarly, with respect to FIG. 5, access network 220 transfers block 511 to MS 202 via time slot 501 and each of frames 1, 2, 3, and 4 and over time period t₁ and transfers block 515 to the MS allocated time slot 505 via time slot 505 and each of frames 1, 2, 3, and 4 and over time period t₁. In turn, each MS allocated a time slot demodulates the data included in the time slot allocated to the MS. As is known in the art, typically four time slots are required to convey a Downlink RLC data block in a GPRS communication system.

During the first time period, access network 220 further determines (310) that a second at least one time slot, allocated to an MS other than MS 202, such as a second MS 208, is available for reallocation. For example, as depicted in FIG. 4, during the first time period neither time slot 404 nor time slot 406 (time slots 504 and 506 with respect to FIG. 5) are fully utilized, that is, time slots 404 and 406 (time slots 504 and 506 with respect to FIG. 5) are vacant during part of the first time period, and more particularly time slots 404 and 504 are vacant in frame 4 and time slots 406 and 506 are vacant in in frames 3 and 4 during the first time period. Such vacancies indicate that time slots 404 and 406 (time slots 504 and 506 with respect to FIG. 5) are available for reallocation. For example, time slots 404 and 406 (time slots 504 and 506 with respect to FIG. 5) may be transmitting voice to their corresponding MSs and, due to the sporadic nature of voice communications, are not fully utilizing the time slots allocated to the corresponding MSs during the first Downlink RLC data block time period.

In response to determining that a second at least one time slot is available for reallocation, access network 220 allocates (312) the second at least one time slot to MS 202. For example, as depicted in FIG. 4, access network 220 may allocate available time slot 404 to MS 202. By way of another example, as depicted in FIG. 5, access network 220 may allocate available time slots 504 and 506 to MS 202. In response to allocating the second at least one time slot to MS 202, access network 220 informs (314) the MS of the allocated time slot(s) via a next Downlink RLC data block transferred to the MS, that is, via a second block (block 421 with respect to FIG. 4 and block 521 with respect to FIG. 5) that is transferred to MS 202 over a corresponding second time period, t₂, and via a time slot previously allocated to the MS, that is, time slot 401 in FIG. 4 and time slot 501 in FIG. 5. In this way, access network 220 may inform MS 202 of the dynamically allocated time slot via a next block that is transferred regardless of the allocation and further is transferred via an already allocated dedicated signaling or bearer channel. By utilizing a next block that is transferred regardless of the allocation, access network 220 may inform the MS of the newly allocated time slot without the specialized messages of, and additional overhead consumed by, the prior art. Furthermore, when the time slot (401/501) previously allocated to MS 202 and used to inform of the allocation is a bearer channel, then communication network 100 provides for in-band signaling of the MS of the newly allocated time slot.

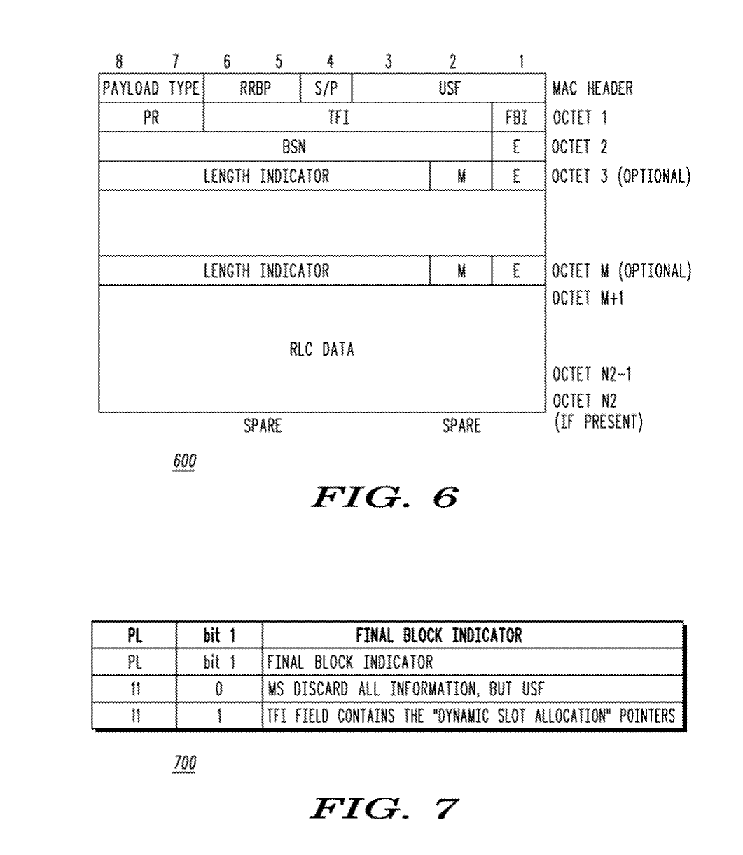

Preferably, access network 220 informs MS 202 of the allocated time slot(s) by identifying the allocated time slot(s) in a header of the next block. For example, FIG. 6 is a bit layout of an exemplary Downlink RLC data block 600 in accordance with an embodiment of the present invention. Downlink RLC data block 600 includes a payload 610 intended for an MS and further includes a MAC layer header 602 that comprises a Payload Type data field 604, a Temporary Flow Identifier (TFI) data field 606, and a Final Block Indicator (FBI) data field 608. Access network 220 indicates to an MS for which block 600 in intended, such as MS 202, that the access network is going to transmit data to the MS via a new time slot in addition to the already assigned time slot by including a bit pattern ‘1 1’ in the Payload Type data field. Further, since dynamically assigning a time slot may be of little value when the block comprising the time slot assignment is a last block of a downlink TBF, access network 220 may further indicate in the header of the next block whether the MS, that is, MS 202, may ignore all information in the block except for an Uplink State Flag (USF), for example, because this a last block of a downlink TBF, or whether the block includes an identifier of an allocated time slot that should be monitored for additional data by the MS. For example, FIG. 7 is a table 700 listing various values that may be assigned to FBI data field 608 and that indicate whether the block includes a pointer to the dynamically allocated time slot in accordance with an embodiment of the present invention. Referring now to FIGS. 6 and 7, by setting a bit pattern ‘1 1’ in Payload Type data field 604 and a value of ‘0’ in FBI data field 608, access network 220 may inform MS 202 that the MS may ignore all information in the block except for the USF. On the other hand, by setting a bit pattern ‘1 1’ in Payload Type data field 604 and a value of ‘1’ in FBI data field 608, access network 220 may inform MS 202 that the block includes a pointer to an assigned time slot, that is, specifically identifies an assigned time slot, that should be monitored for additional data by the MS.

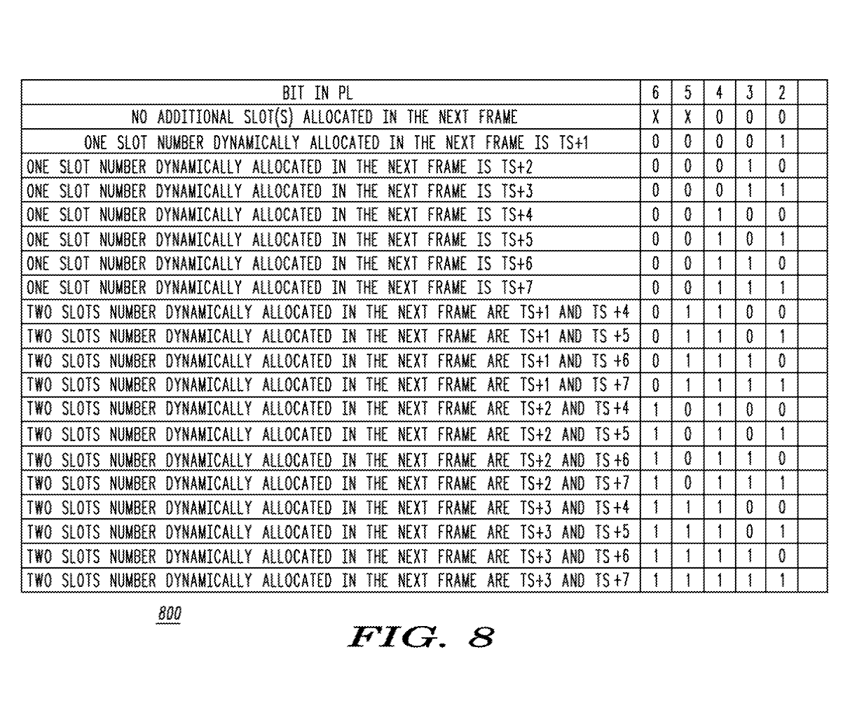

Access network 220 then may identify the time slot allocated to the MS by including a value associated with the time slot in TFI data field 606. FIG. 8 is a table 800 listing various TFI data field 606 bit patterns, and the time slot or time slots associated with each bit pattern, that may be used to point to one or more dynamically allocated time slots in accordance with an embodiment of the present invention. However, one of ordinary skill in the art realizes that many different combinations of bit patterns may be used herein to identify dynamically allocated time slots and the particular combination of bit patterns used herein is not intended to limit the invention in any way. As depicted in table 800, when access network 220 dynamically allocates to an MS a time slot immediately following the time slot currently allocated to the MS (that is, the current time slot (TS) plus one, or TS+1), access network 220 sets the 5 bits of TFI data field 606 to ‘0 0 0 0 1.’ In the case of MS 202, which is currently allocated time slot 401, a bit pattern of ‘0 0 0 0 1’ would inform the MS that time slot 402 has been allocated to the MS in a time period corresponding to a next block. If access network set a bit pattern of ‘0 0 1 1 1,’ this would inform the MS that time slot 400, that is, the time slot immediately preceding currently assigned time slot 401, has been allocated to the MS in the time period corresponding to the next block. All bit patterns described herein, including the bit patterns identifying the dynamically allocated time slots and the associated time slots, are stored in the at least one memory device 206 of MS 202 and a memory of access network 220, such as one or more of at least one memory devices 226 and 234.

For example, referring now to FIG. 4, access network 220 may allocate time slot 404 to MS 202 for use during a third time period, t₃, following the second time period. In such an event and based on table 800, access network 220 would include a bit pattern ‘0 0 0 1 1’ in TFI data field 606 in the second block 421, which second block is conveyed to MS 202 in time slot 401 over the second time period t₂. This bit pattern informs MS 202 that the MS has been further allocated a time slot that is three time slots past the currently allocated time slot, that is, time slot 404, in the next time period, that is, the third time period, t₃, which third time period corresponding to the transfer of a next block 431. By way of another example and referring now to FIG. 5, access network 220 allocates two time slots, that is, time slots 504 and 506, to MS 202 for use during a third time period, t₃, following the second time period t₂. In such an event and based on table 800, access network 220 would include a bit pattern ‘1 1 1 0 1’ in TFI data field 606 in the second block 521, again which second block is conveyed to MS 202 in time slot 501 and over the second time period t₂. This bit pattern informs MS 202 that the MS has been further allocated two time slots, that is, time slots 504 and 506, in the next time period, that is, the third time period t₃, corresponding to the to the transfer of a next block 531, which two time slots are three time slots and five time slots, respectively, past the currently allocated time slot.

Referring again to FIG. 3, after informing MS 202 of the dynamically allocated time slot(s), access network 220 transfers (320) data to the MS over the third time period in the first time slot initially allocated to the MS and in the second at least one time slot additionally and dynamically allocated to the MS since the initial time slot allocation. For example, with respect to FIG. 4, access network 220 transfers data to MS 202 via time slot 401 and Downlink RLC data block 431 and further transfers data to MS 202 via time slot 404 and Downlink RLC data block 434 during the third time period. By way of another example, with respect to FIG. 5, access network 220 transfers data to MS 202 via time slot 501 and Downlink RLC data block 531 and further transfers data to MS 202 via time slots 504 and 506 and Downlink RLC data blocks 534 and 536 during the third time period. In addition, in response to receiving the second block (for example. block 421 with respect to FIG. 4 or b;lock 521 with respect to FIG. 5) and based on the header of the second block, MS 202 determines (316) that the MS has been dynamically allocated one or more time slots in addition to the the time slot initially allocated to the MS, that is, time slot 401 with respect to FIG. 4 or time slot 501 with respect to FIG. 5, and identifies (318) the dynamically allocated time slots, that is, time slot 404 with respect to FIG. 4 or time slots 504 and 506 with respect to FIG. 5. MS 202 then monitors (322) each of the initially allocated time slot, that is, time slot 401 with respect to FIG. 4 or time slot 501 with respect to FIG. 5, and the one or more dynamically allocated time slots, that is, time slot 404 with respect to FIG. 4 or time slots 504 and 506 with respect to FIG. 5, during the third time period t₃. MS 202 demodulates (324) the data included in the monitored time slots during the third time period and logic flow 300 then ends (326).

By utilizing a Downlink RLC data block conveyed to an MS via a first downlink time slot to inform the MS of an allocation of a second downlink time slot, which Downlink RLC data block is conveyed to the MS regardless of the allocation, communication system 100 informs the MS of the dynamically allocated time slot without the specialized messages of, and the additional bandwidth consumed by, the prior art. Furthermore, when the first downlink time slot comprises a bearer channel already allocated to the MS, the system then provides for in-band signaling of the MS of the newly allocated time slot.

While the present invention has been particularly shown and described with reference to particular embodiments thereof, it will be understood by those skilled in the art that various changes may be made and equivalents substituted for elements thereof without departing from the scope of the invention as set forth in the claims below. Accordingly, the specification and figures are to be regarded in an illustrative rather then a restrictive sense, and all such changes and substitutions are intended to be included within the scope of the present invention.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as a critical, required, or essential feature or element of any or all the claims. As used herein, the terms “comprises,” “comprising,” or any variation thereof, are intended to cover a non-exclusive inclusion, such that a process, method, article, or apparatus that comprises a list of elements does not include only those elements but may include other elements not expressly listed or inherent to such process, method, article, or apparatus. It is further understood that the use of relational terms, if any, such as first and second, top and bottom, and the like are used solely to distinguish one entity or action from another entity or action without necessarily requiring or implying any actual such relationship or order between such entities or actions.

What is claimed is:

1. A method for dynamic allocation of a downlink time slot comprising:
allocating a first downlink time slot to a mobile station;
subsequent to allocating the first time slot, determining that a second downlink time slot is available for allocation, wherein the second time slot is different from the first time slot;
allocating the second downlink time slot to the mobile station; and
informing the mobile station of the allocation of the second downlink time slot via a Downlink Radio Link Control (RLC) data block.

2. The method of claim 1, wherein informing comprises:
identifying the second downlink time slot in a header of a Downlink RLC data block; and
transferring the Downlink RLC data block to the mobile station.

3. The method of claim 2, wherein informing further comprises identifying the Downlink RLC data block as comprising an allocation of a downlink time slot.

4. The method of claim 1, wherein informing comprises:
indentifying the second downlink time slot in a header of a Downlink RLC data block; and
transferring the Downlink RLC data block to the mobile station via the first downlink time slot.

5. The method of claim 1, further comprising transferring data to the mobile station in each of the first downlink time slot and the second downlink time slot.

6. A method for dynamic allocation of a downlink time slot comprising:
receiving an allocation of a first downlink time slot;
subsequent to receiving the allocation of the first downlink time slot, receiving a Downlink Radio Link Control (RLC) data block comprising an allocation of a second downlink time slot different from the first time slot;
identifying the second downlink time slot based on the received Downlink RLC data block; and
monitoring each of the first downlink time slot and the second downlink time slot.

7. The method of claim 6, wherein identifying comprises identifying the second downlink time slot based on a header of the received Downlink RLC data block.

8. The method of claim 7, wherein identifying further comprises determining that the Downlink RLC data block block comprises an allocation of a downlink time slot based on the header of the Downlink RLC data block.

9. The method of claim 6, wherein receiving further comprises receiving the Downlink RLC data block via the first time slot.

10. The method of claim 6, further comprising demodulating data included in each of the monitored first downlink time slot and the monitored second downlink time slot.

11. A computer-readable medium that stores instructions for assembling a Downlink Radio Link Control (RLC) data block for conveyance by an access network to a mobile station, wherein the instructions comprise including an identifier of a downlink time slot in a header of the block.

12. The computer-readable medium of claim 11, wherein the instructions further comprise including, in the header, an indication that the Downlink RLC data block comprises an allocation of a downlink time slot.

13. An apparatus comnprising:
means for allocating a first downlink time slot to a mobile station;
means for determining, subsequent to allocating the first time slot, that a second downlink time slot is available for allocation;
means for allocating the second downlink time slot to the mobile station; and
means for conveying a Downlink Radio Link Control (RLC) data block to the mobile station that informs of the allocation of the second downlink time slot.

14. The apparatus of claim 13, wherein the means for informing comprises means for including an identifier of the second downlink time slot in a header of a Downlink RLC data block.

15. The apparatus of claim 14, wherein the means for informing further comprises means for identifying the Downlink RLC data block as comprising a time slot allocation.

16. The apparatus of claim 13, wherein the means for informing comprises:
means for including an identifier of the second downlink time slot in a header of a Downlink RLC data block; and
means for transferring the Downlink RLC data block to the mobile station via the first downlink time slot.

17. The apparatus of claim 13, further comprising means for conveying data to the mobile station in each of the first downlink time slot and the second downlink time slot.

18. A mobile station comprising:
means for receiving an allocation of a first downlink time slot;
means for receiving, subsequent to receiving the allocation of the first downlink time slot, a Downlink Radio Link Control (RLC) data block comprising an allocation of a second downlink time slot;
means for identifying the second downlink time slot based on the received Downlink RLC data block; and
means for monitoring each of the first downlink time slot and the second downlink time slot.

19. The mobile station of claim 18, wherein the means for identifying comprises means for identifying the second downlink time slot based on a header of the received Downlink RLC data block.

20. The mobile station of claim 19, wherein the means for identifying further comprises means for determining that the Downlink RLC data block comprises an allocation of a downlink time slot based on the header of the Downlink RLC data block.

21. The mobile station of claim 18, wherein the means for receiving further comprises means for receiving the Downlink RLC data block via the first time slot.

22. The mobile station of claim 18, further comprising means for demodulating data included in each of the monitored first downlink time slot and the monitored second downlink time slot.

23. A method for in-band signaling of a time slot allocation comprising:
allocating a bearer channel to a mobile station, wherein the bearer channel comprises a first downlink time slot to a mobile station;
subsequent to allocating the bearer channel, determining that a second downlink time slot is available for allocation, wherein the second time slot is different from the first time slot;
allocating the second downlink time slot to the mobile station; and
informing the mobile station of the allocation of the second downlink time slot via the bearer channel.
